(19) United States
(12) Patent Application Publication
(10) Pub. No.: US 2026/0120226 A1
(43) Pub. Date: Apr. 30, 2026

(54) ON-DEMAND GPU ENABLEMENT

(71) Applicant: Dell Products L.P., Round Rock, TX (US)

(72) Inventors: Parminder Singh SETHI, Punjab (IN); Pandiyarajan MANI, Gudiyattam (IN); Praveen KUMAR, Noida (IN); Veena RAMARAO, Bangalore (IN); Vinoth Raja P, Thiruvarur (IN)

(73) Assignee: Dell Products L.P., Round Rock, TX (US)

(21) Appl. No.: 18/929,387

(22) Filed: Oct. 28, 2024

(51) Int. Cl. G06T 1/20

(52) U.S. Cl. CPC G06T 1/20

(57) ABSTRACT

An information handling system may include at least one processor, a memory, and a plurality of graphics processing units (GPUS). The information handling system may be configured to: monitor usage of the plurality of GPUS; in response to the usage of the plurality of GPUs being below a first threshold, execute a command to power off a first number of the plurality of GPUs; and in response to the usage of the plurality of GPUs being above a second threshold, execute a command to power on a second number of the plurality of GPUs.

### TECHNICAL FIELD

The present disclosure relates in general to information handling systems, and more particularly to management of accelerators such as graphics processing units (GPUS).

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may include one or more accelerators such as GPUs. For example, Peripheral Component Interconnect Express (PCIe) GPUs plug into standard PCIe slots. Other GPUs may use the Server PCI Express Module (SXM) form factor or the Open Compute Project (OCP) Accelerator Module (OAM) form factor, which offers bridge technology providing significantly higher interconnect bandwidth compared to PCIe. The SXM architecture is a high-bandwidth socketed solution for planar based GPUs.

In current implementation, GPUs are manually enabled and disabled, without any systematic analysis or automation. For example, suppose that in an 8-GPU server system, 5 GPUS are being fully utilized and 3 are idle. The 3 idle GPUS nevertheless continue to require a power allocation, consume some amount of power, and require cooling. The user might prefer to automatically turn off the idle GPUs or put them into a standby (sleep) mode, returning them to active status only when needed. But this is not currently possible. Embodiments of this disclosure improve on this situation.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with GPU management may be reduced or eliminated.

In accordance with embodiments of the present disclosure, an information handling system may include at least one processor, a memory, and a plurality of graphics processing units (GPUs). The information handling system may be configured to: monitor usage of the plurality of GPUs; in response to the usage of the plurality of GPUs being below a 10 first threshold, execute a command to power off a first number of the plurality of GPUs; and in response to the usage of the plurality of GPUs being above a second threshold, execute a command to power on a second number of the plurality of GPUs.

In accordance with these and other embodiments of the present disclosure, a method an information handling system monitoring usage of a plurality of graphics processing units (GPUs) of the information handling system; in response to the usage of the plurality of GPUs being below a first threshold, the information handling system executing a command to power off a first number of the plurality of GPUs; and in response to the usage of the plurality of GPUS being above a second threshold, the information handling system executing a command to power on a second number of the plurality of GPUS.

In accordance with these and other embodiments of the present disclosure, an article of manufacture may include a non-transitory, computer-readable medium having computer-executable instructions thereon that are executable by an information handling system for: monitoring usage of a plurality of graphics processing units (GPUs) of the information handling system; in response to the usage of the plurality of GPUs being below a first threshold, executing a command to power off a first number of the plurality of GPUs; and in response to the usage of the plurality of GPUS being above a second threshold, executing a command to power on a second number of the plurality of GPUS.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a block diagram of selected components of another example information handling system, in accordance with embodiments of the present disclosure.

### DETAILED DESCRIPTION

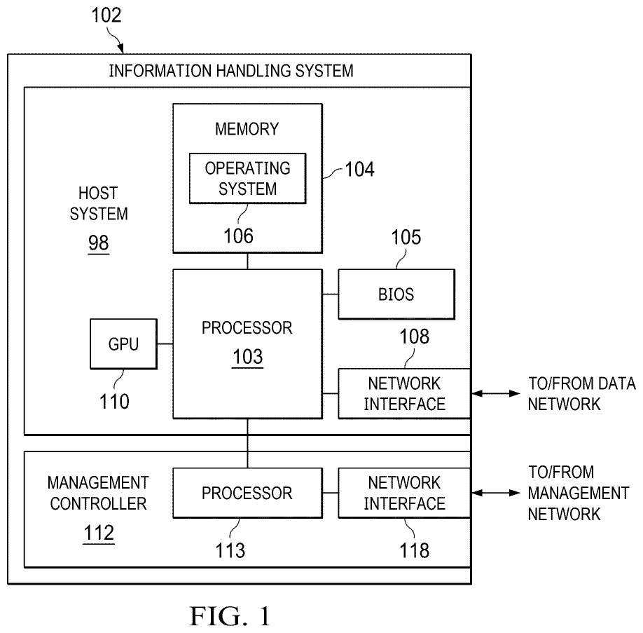

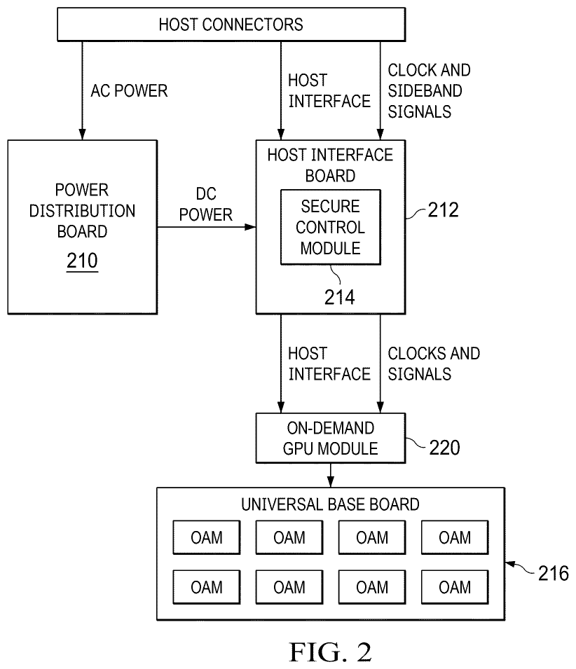

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-include any transitory computer-readable medium) may instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

Information handling system 102 may also include one or more GPUs 110. As discussed above, embodiments of this disclosure may be used to automatically put GPUs into a sleep state when they are not needed, reducing power consumption and cooling requirements. When the GPUs are needed again, they may be automatically woken up and returned to service.

FIG. 2 shows selected components of another information handling system, which includes a universal base board 216 with several OAM GPUs thereon. Universal base board 216 provides modularity and flexibility in supporting current and future GPU modules and design flexibility for system designs. Universal base board 216 provides logic, power, mechanical support, connector interfaces, and thermal infrastructure for each GPU. The example shown supports 8 OAM modules, but specific implementations allow many options for interconnecting fabrics and topologies, power domains, thermal design powers, cooling solutions, and scale-out options.

Host interface board 212 provides connections from the host system to universal base board 216, as shown. Host interface board 212 includes secure control module 214, which aims to move common server management, security, and control features from a typical motherboard into a module designed in a standard form factor, which can be used across various datacenter platforms.

A power distribution board 210 (also known as panelboard, breaker panel, or electric panel) is a component of an electricity supply system that divides an electrical power feed into subsidiary circuits while providing a circuit breaker for each circuit in a common enclosure.

On-demand GPU module 220 may be implemented as hardware, firmware, software, or any combination thereof. In some embodiments, on-demand GPU module 220 may be communicatively coupled to a BMC of the system (not shown) in order to carry out portions of its functionality. In other embodiments, on-demand GPU module 220 may be implemented as executable code that runs on the BMC itself.

On-demand GPU module 220 may analyze the GPU workload and control the enablement of GPUs based on the workload requirements. On-demand GPU module 220 may analyze the work requirements and put the GPU cores which are not in use to sleep. Likewise, if the incoming workload is increasing, on-demand GPU module 220 also ensures that an appropriate number of GPUs are woken from sleep mode. On-demand GPU module 220 may be coupled between host interface board 212 and universal base board 216.

During a first stage of operation, on-demand GPU module 220 may collect all GPU power inventory and workload usage information. This may be accomplished via the BMC with commands such as “racadm getpbinfo” to get power budget information about system components and workloads. There are also third-party tools for specific GPUs that may be used to collect runtime GPU utilization data.

Embodiments of this disclosure may also implement new commands, such as “racadm get GPUUsage N”, “racadm set GPUState N poweroff”, “racadm set GPUState N poweron”, etc. that may be applied to the Nth GPU.

For example, suppose that out of 8 GPUs, 6 are running with full utilization. On-demand GPU module 220 may keep one GPU in standby mode so that it will quickly be ready to use if needed, and turn off the last unused GPU by automatically running the command “racadm set GPUState 1 poweroff”. This may be accomplished based on user-configurable rules that may be defined, such as turning off a certain number of GPUs when utilization falls below a certain threshold, etc.

In another scenario, suppose that out of 8 GPUs, only 3 are running with full utilization. On-demand GPU module 220 may again keep one GPU in standby mode so that it will quickly be ready to use if needed, and turn off the remaining 4 unused GPUS by automatically running the commands “racadm set GPUState X poweroff” for each X value referring to the GPUs being turned off.

In cases where 100% of GPUs are utilized, on-demand GPU module 220 may send an informational notification to the administrator, and if the trend continues it may send a warning notification with a recommendation to add more GPUs.

In a second stage of operation, on-demand GPU module 220 may continue monitoring the GPU usage and the number of GPUs that are required for the workload. Based on user demands, on-demand GPU module 220 has the option to turn on GPUs from sleep mode when needed. Whenever a GPU workload threshold value is reached, the sleeping GPUs may be turned on as needed, and on-demand GPU module 220 may continue to monitor the overall GPU usage and requirements. In some cases, a time-series machine learning model may also be used to predict the upcoming GPU consumption needs by tapping into historical data of the system's GPU utilization, proactively preparing for the future consumption.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor;
a memory; and
a plurality of graphics processing units (GPUs);
wherein the information handling system is configured to:
monitor usage of the plurality of GPUS;
in response to the usage of the plurality of GPUs being below a first threshold, execute a command to power off a first number of the plurality of GPUs; and
in response to the usage of the plurality of GPUs being above a second threshold, execute a command to power on a second number of the plurality of GPUs.

2. The information handling system of claim 1, wherein the commands are executed via a baseboard management controller (BMC) of the information handling system.

3. The information handling system of claim 1, wherein in response to the usage of the plurality of GPUS being below the first threshold, the information handling system is further configured to execute a command to put a third number of the plurality of GPUs into a standby mode.

4. The information handling system of claim 1, further configured to predict a future usage of the plurality of GPUs, wherein the first number and/or the second number is based on the prediction.

5. The information handling system of claim 4, wherein the prediction is based on a time-series machine learning model.

6. The information handling system of claim 1, wherein the first number and/or the second number is based on a set of user-configurable rules.

7. A method comprising:
an information handling system monitoring usage of a plurality of graphics processing units (GPUs) of the information handling system;
in response to the usage of the plurality of GPUs being below a first threshold, the information handling system executing a command to power off a first number of the plurality of GPUs; and
in response to the usage of the plurality of GPUs being above a second threshold, the information handling system executing a command to power on a second number of the plurality of GPUS.

8. The method of claim 7, wherein the commands are executed via a baseboard management controller (BMC) of the information handling system.

9. The method of claim 7, wherein in response to the usage of the plurality of GPUs being below the first threshold, the information handling system is further configured to execute a command to put a third number of the plurality of GPUs into a standby mode.

10. The method of claim 7, further comprising predicting a future usage of the plurality of GPUS, wherein the first number and/or the second number is based on the prediction.

11. The method of claim 10, wherein the prediction is based on a time-series machine learning model.

12. The method of claim 7, wherein the first number and/or the second number is based on a set of user-configurable rules.

13. An article of manufacture comprising a non-transitory, computer-readable medium having computer-executable instructions thereon that are executable by an information handling system for:
monitoring usage of a plurality of graphics processing units (GPUs) of the information handling system;
in response to the usage of the plurality of GPUs being below a first threshold, executing a command to power off a first number of the plurality of GPUs; and
in response to the usage of the plurality of GPUs being above a second threshold, executing a command to power on a second number of the plurality of GPUs.

14. The article of manufacture of claim 13, wherein the commands are executed via a baseboard management controller (BMC) of the information handling system.

15. The article of manufacture of claim 13, wherein in response to the usage of the plurality of GPUs being below the first threshold, the information handling system is further configured to execute a command to put a third number of the plurality of GPUs into a standby mode.

16. The article of manufacture of claim 13, wherein the instructions are further executable for predicting a future usage of the plurality of GPUs, wherein the first number and/or the second number is based on the prediction.

17. The article of manufacture of claim 16, wherein the prediction is based on a time-series machine learning model.

18. The article of manufacture of claim 13, wherein the first number and/or the second number is based on a set of user-configurable rules.
